(19) United States
(12) Patent Application Publication
(10) Pub. No.: US 2024/0190201 A1
(43) Pub. Date: Jun. 13, 2024

(54) HEATING, VENTILATION AND/OR AIR-CONDITIONING DEVICE FOR A MOTOR VEHICLE

(71) Applicant: VALEO SYSTEMES THERMIQUES, La Verriere (FR)

(72) Inventors: Philippe PIERRES, La Verriere (FR); Thierry BARBIER, La Verriere (FR)

(73) Assignee: VALEO SYSTEMES THERMIQUES, La Verriere (FR)

(21) Appl. No.: 18/553,029

(22) PCT Filed: Mar. 31, 2022
(86) PCT No.: PCT/EP2022/058648

§ 371 Date: Sep. 28, 2023

(30) Foreign Application Priority Data
Mar. 31, 2021 (FR) 2103366

(51) Int. Cl. B60H 1/00

(52) U.S. Cl. CPC B60H 1/00028; B60H 2001/00092; B60H 2001/00107

(57) ABSTRACT

Cooling module including a housing configured to accept a tangential-flow turbomachine having a turbine with at least one stage of blades forming a hollow cylinder, the turbomachine also having a motor configured to drive the rotation of the turbine, the motor including a stator and a rotor mounted with the ability to rotate about the stator. The stator of the motor is secured to the housing in such a way that the blades of the turbine are arranged circumferentially around the rotor of the motor, and in that the at least one stage of blades of the turbine is mechanically connected to the rotor of the motor so as to be driven in rotation thereby.

### TECHNICAL FIELD

The invention relates to a heating, ventilation and/or air-conditioning device for a motor vehicle and to a motor vehicle comprising such a device.

### BACKGROUND OF THE INVENTION

Heating, ventilation and/or air-conditioning devices for a motor vehicle are already known, comprising a housing and, inside the housing, one or more heat exchangers and a unit for generating an air flow intended to pass through the exchanger(s) before being distributed in the direction of a passenger compartment of the vehicle through various outlet orifices.

Such devices have a large space requirement and one difficulty is to conceal them under the dashboard. Conventionally, they are situated in a housing situated between the driver and the passenger. Specifically, at this location, the dashboard can extend vertically between the legs of the driver and of the front passenger. Heating, ventilation and/or air-conditioning devices take advantage of this available space by correlatively presenting a large vertical extension.

However, especially for design reasons, it can be desired that the dashboard leaves free space between the legs of the driver and of the front passenger. It is then no longer possible to conceal the heating, ventilation and/or air-conditioning devices in this region and their arrangement must be reviewed.

According to a first aspect of the invention, a more horizontal distribution of the components of the heating, ventilation and/or air-conditioning devices is provided. However, such a distribution must remain compatible with an appropriate overall space requirement of said devices in the passenger compartment of the vehicle.

### BRIEF SUMMARY OF THE INVENTION

The aim of the invention is to overcome at least some of the difficulties mentioned above and to this end it proposes a heating, ventilation and/or air-conditioning device for a motor vehicle, said device having a space requirement, referred to as vertical, in a direction, referred to as vertical, Z-Z′, said device comprising a housing and, inside the housing, a first heat exchanger and a unit for generating an air flow, said first exchanger extending in a direction close to said vertical direction Z-Z′ and a direction, referred to as transverse, Y-Y′, perpendicular to the vertical direction Z-Z′, said unit for generating the air flow comprising a blower wheel configured to rotate about an axis of rotation, oriented substantially in said transverse direction Y-Y′, and to generate the air flow tangentially in the direction of said first exchanger, said blower wheel being arranged so as to remain in a vertical space requirement of said first exchanger, said housing being configured to extend on either side of a wall separating an engine compartment from a passenger compartment of the vehicle, a first part of the housing accommodating the unit for generating the air flow being intended to be situated on the engine compartment side and a second part of the housing accommodating the first exchanger being intended to be situated on the passenger compartment side.

The vertical direction Z-Z′ of the device is intended to be parallel to the vertical axis “Z” of the vehicle, in use, that is to say after installation in the vehicle.

Placing the blower wheel in the vertical space requirement of the exchanger avoids increasing the vertical space requirement of the housing. In addition, by orienting said blower wheel in the transverse direction, this allows an air supply to the air generation unit in the axial extension of the blower wheel. This also avoids increasing the vertical space requirement of the device. Moreover, by placing the part of the housing comprising the blower wheel on the engine compartment side, its horizontal extension in the passenger compartment is limited. It is thus possible to benefit from a device with a limited vertical and horizontal spatial footprint on the passenger compartment side.

Advantageously, the vertical space requirement of said housing is maximum in a zone for guiding the air flow toward said first exchanger and/or in line with said first exchanger.

By placing the first exchanger and its air supply close to the region of the housing having the greatest vertical space requirement, the exchange surface of the first exchanger and the flow sections of the air flow in the direction of this first exchanger are preserved. This optimizes the thermal efficiency of the device.

According to other features of the invention, which can be used alone or together according to any technically possible combinations, which form as many embodiments of the invention:
said housing is configured to direct the air flow at the outlet of the blower wheel directly toward said first exchanger, without change of direction,
said first exchanger comprises a heat exchange bundle extending mainly in a first direction I-I′, having a limited angle, for example less than 15°, with respect to said vertical direction, and in the transverse direction Y-Y′,
said first exchanger has transverse sides extending in said transverse direction Y-Y′ and in a direction, referred to as bundle thickness direction, J-J′, perpendicular to said first direction I-I′ and to said transverse direction Y-Y′,
said housing has a chamber for supplying air to said first exchanger that has a divergent shape in the direction of flow of the air flow along said bundle thickness direction J-J′,
said unit for generating the air flow, in particular said blower wheel, is situated between two parallel planes extending the transverse sides of the first exchanger,
said first exchanger has lateral sides extending in said first direction I-I′ and said bundle thickness direction J-J′,
said unit for generating the air flow is substantially centred in said transverse direction Y-Y′ between two planes extending said lateral sides of the first exchanger,
said device comprises, inside the housing 1, a second heat exchanger,
said second heat exchanger is situated downstream of said first exchanger in the direction of flow of the air flow,
said second exchanger comprises a heat exchange bundle extending mainly in said transverse direction Y-Y′ and in a second direction K-K′, intended to have a limited angle, for example less than 10°, with respect to a direction orthogonal to the first direction I-I′,
said second exchanger is situated between said parallel planes extending the transverse sides of the first exchanger and/or between the parallel planes extending the lateral sides of said first exchanger,
said housing defines a flow channel for the air flow with:
at least one first duct for a first air flow, defining a first air outlet,
at least one second duct for a second air flow, defining a second air outlet,
at least one mixing chamber communicating with the respective air outlets of said ducts, and
at least one mixing flap comprising a first sliding door arranged so as to control the distribution of the first and second air flows in said mixing chamber, said mixing flap being arranged so that it can move between a first end position closing off the first duct, and a second end position closing off the second duct,
the first duct directly connecting the first heat exchanger to the mixing chamber, bypassing the second heat exchanger,
the second duct connecting the first exchanger to the mixing chamber, guiding the air through the second heat exchanger,
the device comprises one or more air outlet openings arranged downstream of the mixing chamber, each air outlet opening being configured to guide the air flow to various regions of a vehicle passenger compartment,
the device comprises a first distribution flap comprising a second sliding door arranged so as to be able to close off at least partially one of said air outlet openings,
the device comprises an air inlet module positioned in the extension of said unit for generating the air flow along the transverse axis Y-Y′,
said air inlet module comprises a first air inlet, configured to receive air from outside the vehicle,
the air inlet module comprises a second air inlet, configured to receive air from a vehicle passenger compartment,
said second air inlet extends transversely, in particular orthogonally, from a lateral wall of the housing,
the first part of the housing accommodating the unit for generating the air flow also accommodates the air inlet module,
said housing comprises a bearing surface intended to come against said wall separating the engine compartment and the passenger compartment, said bearing surface is intended to be oriented substantially vertically, in use,
the first exchanger is an evaporator,
the second exchanger is a heating radiator.

The invention also relates to a vehicle comprising an engine compartment, a passenger compartment and a wall separating said engine compartment from said passenger compartment, said vehicle further comprising a heating, ventilation and/or air-conditioning device as described above.

### BRIEF DESCRIPTION OF THE DRAWINGS

Other features and advantages of the invention will become apparent on reading the following description, with reference to the appended figures, in which:

FIG. 1 illustrates, in a longitudinal sectional plane, an exemplary embodiment of the heating, ventilation and/or air-conditioning device according to the invention;

FIG. 2 illustrates a perspective view of the device of FIG. 1, from a first angle of view; and

FIG. 3 illustrates a perspective view of the device of FIG. 1, from another angle of view.

### DETAILED DESCRIPTION OF THE INVENTION

The terms “upstream” and “downstream” are always in reference to the flow of an air flow circulating within the heating, ventilation and/or air-conditioning device.

The figures schematically show a trihedron XYZ where a longitudinal axis X of the heating, ventilation and/or air-conditioning device can correspond to the front/rear longitudinal axis of the vehicle. A transverse axis Y of the heating, ventilation and/or air-conditioning device can correspond to the right/left transverse axis of the vehicle, and a vertical axis Z of the heating, ventilation and/or air-conditioning device can correspond to the top/bottom vertical axis of the vehicle, each axis being perpendicular to one another, in particular when the heating, ventilation and/or air-conditioning device is installed in the motor vehicle.

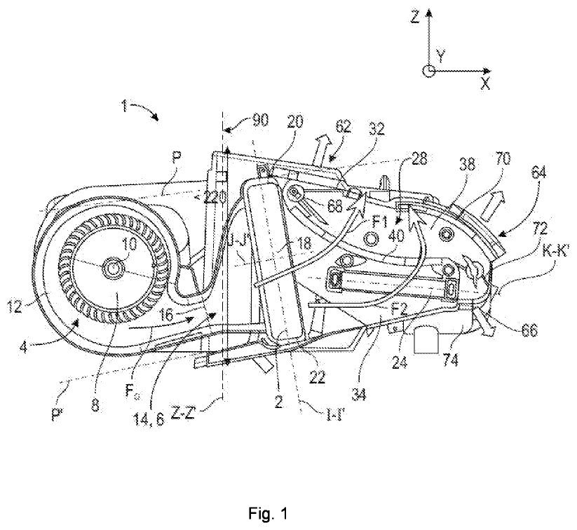

As illustrated in FIG. 1, the invention relates to a heating, ventilation and/or air-conditioning device for a motor vehicle, said device having a space requirement, referred to as vertical, in a direction, referred to as vertical, Z-Z′. This is in particular a direction parallel to the vertical axis “Z” of the vehicle, after installation of said device in the vehicle.

Said device comprises a housing 1 and, inside the housing 1, a first heat exchanger 2 and a unit 4 for generating an air flow.

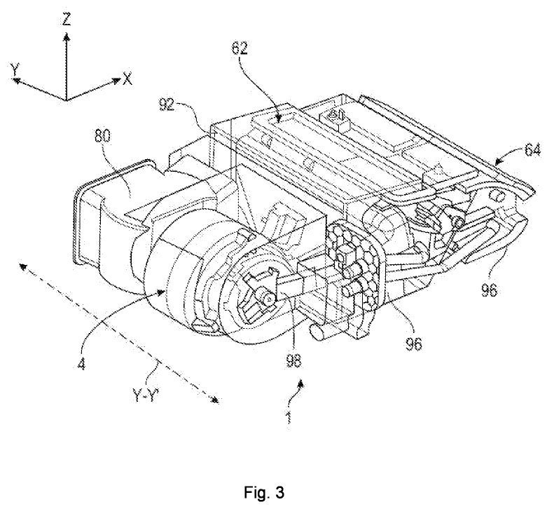

Said first exchanger 2 extends mainly in a direction close to said vertical direction Z-Z′ and a direction, referred to as transverse, Y-Y′, perpendicular to the vertical direction Z-Z′, and corresponding to the normal to the plane of FIG. 1 and illustrated in FIG. 3. This is, for example, an evaporator. It is thus used to dehumidify and/or cool the air flow.

Said unit 4 for generating the air flow comprises a blower wheel 8 configured to rotate about an axis of rotation 10. In particular, it is a radial blower wheel or volute. Said unit 4 for generating the air flow further comprises an electric motor for driving the blower wheel 8, said motor not being illustrated in the figures. Said motor comprises, for example, a stator and a rotor, which are oriented along said axis of rotation 10 of the blower wheel 8. The motor is positioned, in particular, inside a volume defined by said blower wheel 8. It does not modify the vertical space requirement of the unit 4 for generating the air flow. It also does not modify, or only slightly modifies, a space requirement of said air generation unit in said transverse direction Y-Y′.

Advantageously, the vertical space requirement of said housing 1 is chosen to be maximum in a zone 6 for guiding the air flow toward said first exchanger 2 and/or in line with said first exchanger 2. In this way, there is a flow section for the air flow in the direction of the first exchanger 2 which limits the pressure drops on the air and/or a surface for exchange with the air which is as extensive as possible at said first exchanger 2. While limiting the vertical space requirement, such a configuration thus makes it possible to maintain significant energy and/or thermal performance.

According to the invention, said axis of rotation 10 of the blower wheel 8 is oriented substantially in said transverse direction Y-Y′ and said blower wheel 8 is configured to generate the air flow tangentially, along the arrow marked F0, in the direction of said first exchanger 2. Said blower wheel 8 is furthermore arranged so as to remain in a vertical space requirement of said first exchanger 2. Thus, said blower wheel 8 can have a large diameter and generate a significant air flow without impacting the vertical space requirement of the housing 1. In addition, the orientation of the blower wheel 8 favors an air supply to the unit 4 for generating the air flow in said transverse direction Y-Y′, which also contributes to preserving the vertical space requirement of the device while limiting the pressure drops on the air.

The invention also extends to a device in which the blower wheel 8, while retaining the same orientation, would have a positioning and/or a diameter which would make it depart from the vertical space requirement of the first exchanger 2 as long as, taking into account the wall thicknesses of the housing 1, such a blower wheel does not cause an increase in the vertical space requirement of the housing relative to that which said housing 1 has in the zone 6 for guiding the air flow toward said first exchanger 2 and/or in line with said first exchanger 2.

Preferably, said housing is configured to direct the air flow at the outlet of the blower wheel 8 directly toward said first exchanger 2, without any bend or change of direction. This helps to limit pressure drops on the air.

As is the case in the embodiment illustrated, said housing 1 has a first chamber 12 in which said unit 4 for generating the air flow is situated. Said housing also has a second chamber 14 defining the zone 6 for guiding the air flow toward said first exchanger 2 and forming a space for supplying air to said first exchanger 2. Said first chamber 12 has, for example, a cylindrical configuration, of circular cross section, centered on the axis of rotation 10 of the blower wheel 8.

Said housing 1 also has a communication orifice 16 between said first chamber 12 and said second chamber 14 so that the air passes directly from one to the other. Said communication orifice 16 extends along said transverse direction Y-Y′ along the same extent as said blower wheel 8 and/or said first exchanger 2 in the same direction. The air flow is generated tangentially to a lower part of the blower wheel 8 and passes from the first chamber 12 to the second chamber 14 via the communication orifice 16, without any bend or change of direction, said communication orifice 16 being positioned at the lower part of said housing 1.

Said first exchanger 2 advantageously comprises a heat exchange bundle 18 extending mainly in a first direction I-I′ having a limited angle, for example less than 15°, with respect to said vertical direction, and in the transverse direction Y-Y′. Here, said first exchanger 2 is slightly inclined with respect to the vertical, but it can also be oriented vertically.

Said first exchanger 2 has transverse sides 20, 22 extending in said transverse direction Y-Y′ and in a direction, referred to as bundle thickness direction, J-J′, perpendicular to said first direction I-I′ and to said transverse direction Y-Y′. Said transverse sides 20, 22 respectively form here upper and lower sides of the first exchanger 2. Said first exchanger 2 also has lateral sides, not visible in the figures, extending in said first direction I-I′ and said bundle thickness direction J-J′. Said lateral sides here respectively form right and left sides of the first exchanger 2. They connect the transverse sides 20, 22.

In such a configuration, said unit 4 for generating the air flow, in particular said blower wheel 8, are situated between two parallel planes P, P′ extending the transverse sides 20, 22 of the first exchanger 2.

Preferably, said unit 4 for generating the air flow and/or said blower wheel 8 are substantially centered along said transverse axis Y-Y′ with respect to said first exchanger 2. This allows a good distribution of the air flow while limiting the space requirement of the device in this direction. More precisely, here, said unit 4 for generating the air flow and/or said blower wheel 8 are substantially centered in said transverse direction Y-Y′ between two planes extending said lateral sides of the exchanger.

It can also be noted that said second chamber 14 preferably has a divergent shape in the direction of flow of the air flow along said bundle thickness direction J-J′.

Said device further comprises, inside the housing 1, a second heat exchanger 24. This is, for example, a heating radiator. It is thus used to heat the air passing through it.

Said second heat exchanger 24 is situated downstream of said first exchanger 2, in the direction of flow of the air flow. Said housing 1 here defines, downstream of the first exchanger 2, a volume 28, referred to as the downstream volume, separated from the second chamber 14 by said first exchanger 2. Said second exchanger 24 is situated in said downstream volume 28.

Said second exchanger 24 comprises a heat exchange bundle extending mainly in said transverse direction Y-Y′ and in a second direction K-K′, intended to have a limited angle, for example less than 10°, with respect to a direction orthogonal to the first direction I-I′ and/or with respect to the horizontal, in use.

Said second exchanger 24 is preferably situated between said parallel planes P, P′ extending the transverse sides 20, 22 of the first exchanger 2 and/or between the parallel planes extending the lateral sides of said first exchanger 2.

Said housing 1 defines, in said downstream volume 28, at least one first duct 32 for the flow of a first air flow F1, defining a first outlet, and at least one second duct 34 for the flow of a second air flow F2, defining a second outlet. It also defines at least one mixing chamber 38, communicating with the respective outlets of said ducts 32, 34.

Said device further comprises at least one mixing flap 40 comprising a first sliding door arranged so as to control the distribution of the first F1 and second F2 air flows in said mixing chamber 38. Said mixing flap 40 is arranged so that it can move between a first end position, closing off the first outlet, that is to say the outlet of the first duct 32, and a second end position closing off the second outlet, that is to say the outlet of the second duct 34.

The first duct 32 connects the first heat exchanger 2 directly to the mixing chamber 38, bypassing the second heat exchanger 24. The second duct 34 connects the first exchanger 2 to the mixing chamber 38 by passing through the second heat exchanger 24. In other words, the entire air flow coming from the unit 4 for generating the air flow passes systematically through the first exchanger 2 and only that part of the air flow possibly flowing through the second duct 34 passes through said second exchanger 24, the other part bypassing said second exchanger 24. Thus, in the example, only that part of the air flow possibly passing through the second duct 34 is heated.

The position of the mixing flap 40 is determined according to the selected air-conditioning mode and temperature. When said mixing flap 40 is in its first end position, the entire air flow passes through the second duct 34 to undergo heating. When the mixing flap 40 is in its second end position, the entire air flow passes through the first duct 32, without undergoing heating. When said mixing flap 40 is in an intermediate position, the air flow is divided at the outlet of the first exchanger 2 between the first duct 32 and the second duct 34. The corresponding flows F1, cold, and F2, hot, are then found in the mixing chamber 38 to form an air flow of intermediate temperature, as illustrated in FIG. 1.

Said housing 1 comprises here at least one air outlet opening 62, 64, 66 arranged downstream of the mixing chamber 38, each air outlet opening 62, 64, 66 being configured to guide the flow toward various regions of the passenger compartment of the vehicle. What is concerned, for example, is a first air outlet opening 62 in the direction of a windshield of the vehicle, situated in the upper part of the housing 1, a second air outlet opening 64 in the direction of the upper body of the driver or of the passengers of the vehicle, situated in the front part of the housing 1, or a third air outlet opening 66, in the direction of the feet of the driver and/or of the front passenger.

Advantageously, said device further comprises a first, a second and/or a third distribution flap 68, 70, 72, respectively arranged so as to be able to at least partially close off the first, the second and/or the third of said air outlet openings 62, 64, 66. A distribution flap is provided here for each of said outlet openings 62, 64, 66. In a variant, some of said flaps can be common to a plurality of outlet openings.

The flap or flaps are formed, for example, by a sliding door, a butterfly flap and/or a flag flap. Here, said first flap 68 is formed, in particular, by a flag flap. Said second distribution flap 70 is formed, in particular, by a second sliding door. The third flap 72 is formed, in particular, by a butterfly flap.

Said housing 1 further comprises here one or more air flow channels 74 connected to said third opening 66 and intended to guide the air in the lower part of the passenger compartment.

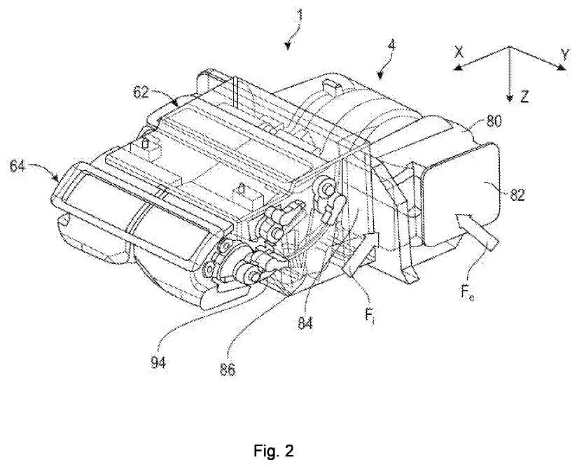

As can be seen more clearly in FIGS. 2 and 3, the device further comprises an air inlet module 80. Said air inlet module makes it possible to supply said unit 4 for generating an air flow. It comprises, for example, an air filter. Said air inlet module 80 is advantageously positioned in the extension of said unit 4 for generating the air flow along the transverse axis Y-Y′, at the inlet of said unit 4.

Said air inlet module 80 comprises a first air inlet 82, configured to receive air coming from outside the vehicle, in the direction of the arrow marked Fe. Said air inlet 82 here extends in the extension of the axis of rotation 10 of the blower wheel 8. It is situated in a plane orthogonal to said axis of rotation 10.

The air inlet module further comprises a second air inlet 84, configured to receive air coming from a passenger compartment of the vehicle, in the direction of the arrow marked Fi. Said second air inlet 84 extends transversely, in particular orthogonally, from a lateral wall 86 of the housing. Said second air inlet 84 is situated in a plane orthogonal to said first air inlet 82.

Again according to the invention, said housing 1 is configured to extend on either side of a wall 90, illustrated schematically in dotted lines in FIG. 1. Said wall 90 separates an engine compartment from the passenger compartment of the vehicle.

A first part of the housing 1 accommodating the unit 4 for generating the air flow and, possibly, the air inlet module 80 are intended to be situated on the engine compartment side. In this way, the horizontal space requirement of the device in the passenger compartment is limited. A second part of the housing 1 accommodating the first exchanger 2 and the downstream volume 26 is intended to be situated on the passenger compartment side. The second chamber 14 is situated, for example, on either side of said wall 90.

Said housing comprises here a bearing surface 92 intended to come against said wall 90 separating the engine compartment and the passenger compartment. Said bearing surface 92 is intended to be oriented substantially vertically, in use.

It will be noted that said device further comprises one or more actuators 94 intended to move the mixing flap 40 and the distribution flap or flaps 62, 64, 66. It also comprises one or more connections 96 enabling the first exchanger 2 and/or the second exchanger 24 to be supplied with the fluid or fluids intended to pass through them. These are, for example, a refrigerant and a heat-transfer fluid respectively.

Advantageously, said actuator(s) 94 are situated on a lateral wall of the housing 1, corresponding here to the lateral wall 86 from which said second air inlet 84 extends, and said connector(s) 96 are situated on an opposite lateral wall.

Said device further comprises an electrical power supply 98 for the unit 4 for generating the air flow. Said electrical power supply 98 is configured to pass through said partition 90. Said electrical power supply is situated, for example, along one of the lateral walls of the housing 1, in particular that carrying said connection or connections 96.

What is claimed is:

1. A heating, ventilation and/or air-conditioning device for a motor vehicle, said device having a vertical dimension defined along a vertical direction, said heating, ventilation and/or air-conditioning device comprising a housing and, inside the housing, a first heat exchanger and a unit for generating an air flow, said first exchanger extending in a direction close to said vertical direction to define a vertical dimension of the first heat exchanger and also extending in a transverse direction, along a transverse axis, perpendicular to the vertical direction, said unit for generating the air flow including a wheel configured to rotate about an axis of rotation, oriented substantially in said transverse direction, and to generate the air flow tangentially in the direction of said first exchanger, said wheel being arranged so as to remain within the vertical dimension of said first exchanger when viewed perpendicularly to the vertical direction, said housing being configured to extend on either side of a wall separating an engine compartment from a passenger compartment of the motor vehicle, a first part of the housing accommodating the unit for generating the air flow being intended to be situated on the engine compartment side and a second part of the housing accommodating the first exchanger being intended to be situated on the passenger compartment side.

2. The heating, ventilation and/or air-conditioning device as claimed in claim 1, wherein a vertical dimension of said housing, defined along the vertical direction, is maximum in a zone for guiding the air flow toward said first exchanger and in line with said first exchanger.

3. The heating, ventilation and/or air-conditioning device as claimed in claim 1, wherein said unit for generating the air flow is substantially centered along said transverse axis with respect to said first exchanger.

4. The heating, ventilation and/or air-conditioning device as claimed in claim 1, wherein said first exchanger includes a heat exchange bundle extending mainly in a first direction at an angle with respect to said vertical direction, and in the transverse direction.

5. The heating, ventilation and/or air-conditioning device as claimed in claim 4, wherein said first exchanger has transverse sides extending in said transverse direction and in a direction, referred to as bundle thickness direction, perpendicular to said first direction and to said transverse direction.

6. The heating, ventilation and/or air-conditioning device as claimed in claim 5, wherein said housing has a chamber for supplying air to said first exchanger that has a divergent shape in the direction of flow of the air flow along said bundle thickness direction.

7. The heating, ventilation and/or air-conditioning device as claimed in claim 5, wherein said unit for generating the air flow is situated between two parallel planes extending the transverse sides of the first exchanger.

8. The heating, ventilation and/or air-conditioning device as claimed in claim 5, wherein said first exchanger has lateral sides extending in said first direction and said bundle thickness direction.

9. The heating, ventilation and/or air-conditioning device as claimed in claim 8, wherein said unit for generating the air flow is substantially centered in said transverse direction between two planes extending said lateral sides of the first exchanger.

10. A vehicle comprising an engine compartment, a passenger compartment and a separation wall between said engine compartment and said passenger compartment, said vehicle further comprising a heating, ventilation and/or air-conditioning device for a motor vehicle, said device having a vertical dimension defined along a vertical direction, said heating, ventilation and/or air-conditioning device including a housing and, inside the housing, a first heat exchanger and a unit for generating an air flow, said first exchanger extending in a direction close to said vertical direction to define a vertical dimension of the first heat exchanger and also extending in a transverse direction, along a transverse axis, perpendicular to the vertical direction, said unit for generating the air flow including a blower wheel configured to rotate about an axis of rotation, oriented substantially in said transverse direction, and to generate the air flow tangentially in the direction of said first exchanger, said blower wheel being arranged so as to remain within the vertical dimension of said first exchanger when viewed perpendicularly to the vertical direction, said housing being configured to extend on either side of a wall separating an engine compartment from a passenger compartment of the motor vehicle, a first part of the housing accommodating the unit for generating the air flow being intended to be situated on the engine compartment side and a second part of the housing accommodating the first exchanger being intended to be situated on the passenger compartment side.

11. The heating, ventilation and/or air-conditioning device as claimed in claim 1, wherein the vertical dimension of said housing is maximum in a zone for guiding the air flow toward said first exchanger or in line with said first exchanger.
